(19) United States
(12) Patent Application Publication
(10) Pub. No.: US 2012/0082385 A1
(43) Pub. Date: Apr. 5, 2012

(54) EDGE BASED TEMPLATE MATCHING

(75) Inventors: Xinyu Xu, Vancouver, WA (US); Xiaofan Feng, Camas, WA (US)

(73) Assignee: SHARP LABORATORIES OF AMERICA, INC., Camas, WA (US)

(21) Appl. No.: 12/894,676

(22) Filed: Sep. 30, 2010

(51) Int. Cl. G06K 9/48; G06K 9/68

(52) U.S. Cl. 382/199; 382/218

(57) ABSTRACT

A method for image processing includes decomposing a model image into at least one lower resolution image and determining generally rotation invariant characteristics of a model object of the lower resolution image and an object orientation of the model object of the lower resolution image using an edge based technique. Decomposing the image into at least another lower resolution image and determining a candidate test object's position within another lower resolution image and an orientation of the test object using an edge based technique. The orientation ambiguity of the test object is resolved.

### CROSS-REFERENCE TO RELATED APPLICATIONS

None.

### BACKGROUND OF THE INVENTION

The present invention relates generally to template matching for an image.

Referring to FIG. 1, template matching is a commonly used technique in order to recognize content in an image. The template matching technique includes a given target object in a model image, automatically finding the position, orientation, and scaling of the target object in input images. Generally, the input images undergo geometric transforms (rotation, zoom, etc) and photometric changes (brightness/contrast changes, blur, noise, etc). In the context of template matching, the relevant characteristics of the target object in the model image may be assumed to be known before the template matching to the target image is performed. Such characteristics of the target object may be extracted, modeled, and learned previously in a manner that may be considered “off-line,” while the matching of those characteristics to the input image may be considered “on-line.”

One of the template matching techniques includes feature point based template matching which achieves good matching accuracy. Feature point based template matching extracts object discriminative interesting points and features from the model and the input images. Then those features are matched between the model image and the input image with K-nearest neighbor search or some feature point classification technique. Next a homography transformation is estimated from those matched feature points, which may further be refined.

Feature point based template matching works well when objects contain a sufficient number of interesting feature points. It typically fails to produce a valid homography when the target object in the input or model image contains few or no interesting points (e.g. corners), or the target object is very simple (e.g. target object consists of only edges, like paper clip) or symmetric, or the target object contains repetitive patterns (e.g. machine screw). In these situations, too many ambiguous matches prevents generating a valid homography. To reduce the likelihood of such failure, global information of the object such as edges, contours, or shape may be utilized instead of merely relying on local features.

Another category of template matching is to search the target object by sliding a window of the reference template in a pixel-by-pixel manner, and computing the degree of similarity between them, where the similarity metric is commonly given by correlation or normalized cross correlation. Pixel-by-pixel template matching is very time-consuming and computationally expensive. For an input image of size N×N and the model image of size W×W, the computational complexity is O(W²×N²), given that the object orientation in both the input and model image is coincident. When searching for an object with arbitrary orientation, one technique is to do template matching with the model image rotated in every possible orientation, which makes the matching scheme far more computationally expensive. To reduce the computation time, coarse-to-fine, multi-resolution template matching may be used.

What is desired therefore is a computationally efficient edge based matching technique.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates template matching.

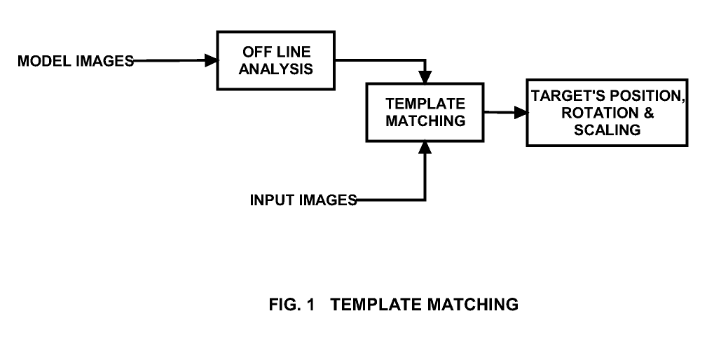

FIG. 2 illustrates an improved template matching technique.

FIG. 3 illustrates details of the template matching technique of FIG. 2.

FIG. 4 illustrates multi-resolution image decomposition.

FIG. 5 illustrates edge map computation.

FIG. 6 illustrates an adaptive threshold for edge maps.

FIG. 7 illustrates candidate position and span determination.

FIG. 8 illustrates multi-orientation NCC matching.

FIG. 9 illustrates matching feature extraction for input and template images.

FIG. 10 illustrates a mapping function.

FIG. 11 illustrates coarse orientation search.

FIG. 12 illustrates pseudo code for multi-object coarse angle search.

FIG. 13 illustrates pseudo code for a single object coarse angle search.

FIG. 14 illustrate dynamically determining a coarse sampling interval.

FIG. 15 illustrates fine angle search.

FIG. 16 illustrates removal of false positives.

### DETAILED DESCRIPTION OF PREFERRED EMBODIMENT

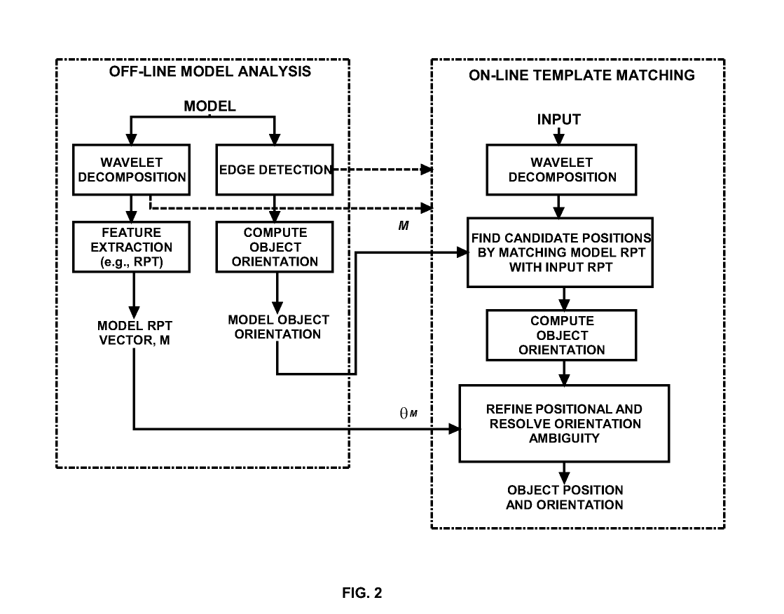

Referring to FIG. 2, a multi-resolution, edge-based template matching is suitable to achieve accurate matching even when object is simple or contains repetitive patterns. The preferred technique includes an offline model image analysis and an online template matching phase. The offline model analysis can be viewed as a training process, so the time and computational resources used are of minor concern. In contrast, the online template matching technique should require fewer computational resources and perform the template matching considerably faster.

In the off-line model analysis, two principal types of information are gathered which is used for online template matching. The first type of information is for finding object position, which may include wavelet decomposition of the model image into multiple layers and a generally rotation-invariant feature of the target object in the model image, thus providing a model vector M. Any suitable technique may be used for decomposing the image into multiple layers, which facilitates more computational efficiency due to the reduced image size. The preferred technique for a generally rotation invariant feature is a ring projection transform, although any suitable technique may be used. The generally rotation invariant feature facilitates object identification without having to check a significant number of different angles (or no different angles) for the model images. The model vector M is thus determined for the model image based upon the ring projection transform. Other characteristics may likewise be determined that are characteristic of the object that include a generally rotation invariant feature based upon a lower resolution image.

The second type of information is for determining the model object orientation, which may include edge detection and orientation estimation thus providing model object orientation. The orientation estimation determines candidate positions for the object using the generally rotation invariant characteristic on the lower resolution image. In this manner, potential candidate locations can be determined in an efficient manner without having to check multiple angular rotations of the object.

In the online template matching, input image is first decomposed into lower resolution with a wavelet decomposition, the number of decomposition layers is determined by the offline model analysis based on the model image size. Other decomposition techniques may likewise be used, as desired. Then candidate positions and a span of the target object are identified by measuring the similarity between the model rotation invariant feature and a rotation invariant feature centered at each high energy pixel in the lowest resolution input wavelet composite subimage, and selecting the positions where the similarity is higher than a predefined threshold. Then the system can verify candidate positions by computing the correlation coefficients in the vicinity of their corresponding ones in the original highest resolution image. Candidates with highest correlation coefficients are kept as the final target object position. In this manner, the initial matching is done in a generally rotation invariant manner (or rotation invariant manner) for computational efficiency. After an object position is determined, the system may then estimate object orientation in input by detecting edges in the span of object and computing image moments using the edge map. Thus, after a likely determination is made of a candidate position, the system can then account for image rotation, which is a computationally efficient technique. Then any ambiguous orientation is resolved and the model image is aligned to the input by translating and rotating the model image to the estimated input position and orientation.

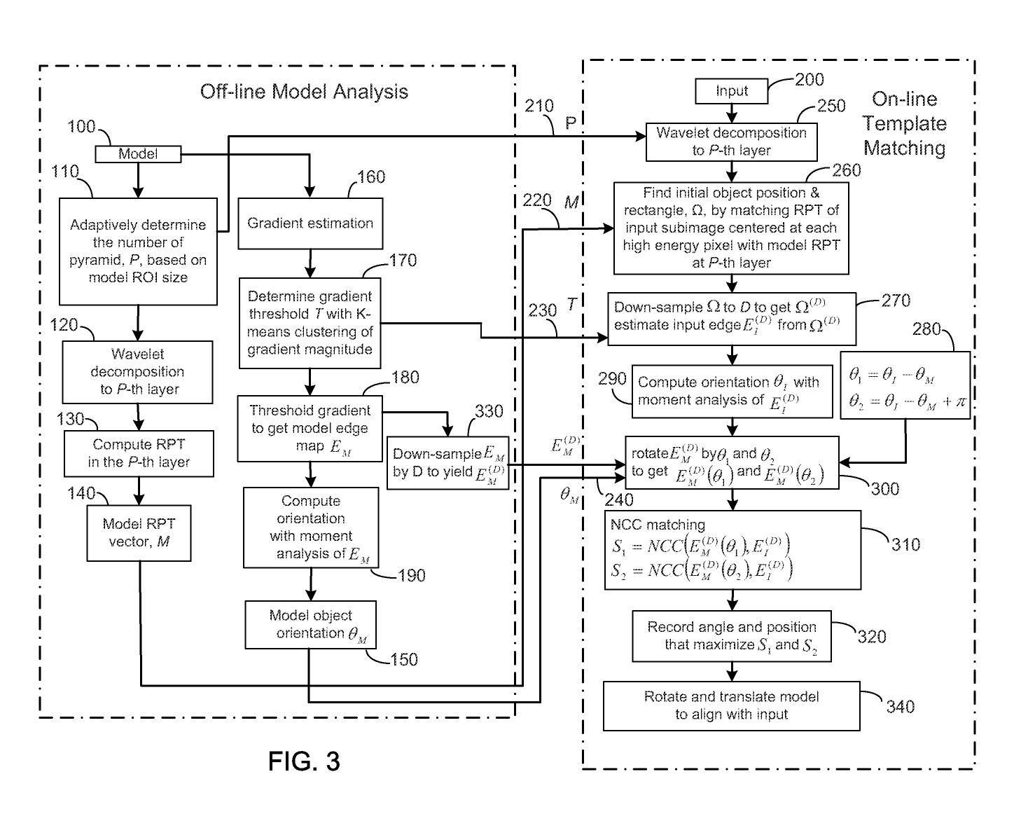

Referring to FIG. 3, a more detailed description is provided of the preferred embodiments. In the offline model analysis the system determines the number of wavelet decomposition layers 100 for the particular input model 100. The effective size of the smallest subimages in the decomposition should be used as a stopping criteria for determining the maximum number of decomposition levels. If the decomposed subimage is over-downsampled, the locations and the wavelet coefficient values of object feature may change dramatically from sample to sample, and hence generate false matching accordingly. Empirical testing indicates that the smallest size of a decomposed model subimage should be no smaller than about 64×64 (or other sizes). Thus the number of decomposition layers may be determined based on the model image size and the constraint that the smallest layer cannot be smaller than generally 64×64. For example, for a 320×320 model image the number of decomposition layer may be 2, that is, the down-sample factor is 2²=4. Likewise, In the wavelet decomposition for the online template matching, the input image should also be decomposed by a factor of 4. Other image decomposition techniques may be used as desired.

Motivated by a desire for an efficient template matching scheme so that an arbitrarily orientated object can be detected in an input image, the system may use a multi-resolution template matching with the wavelet decomposition. The wavelet decomposition reduces an image to small subimages at multiple low-resolution levels 120. It also transforms the image into a representation where both spatial and frequency information is present. In addition, by using wavelet coefficients as features, it has the property that the matching is not very sensitive to the photometric changes (such as background and/or foreground intensity change, illumination change). By highlighting local feature points with high energy in the decomposed subimages, it results in significant computation saving in the matching process.

The wavelet transform of a 2D image f(x, y) may be defined as the correlation between the image and a family of wavelet functions {φ_{s,t}(x,y)}:

W_{f}(s,t;x,y)=f(x,y)*φ_{s,t}(x,y) (1)

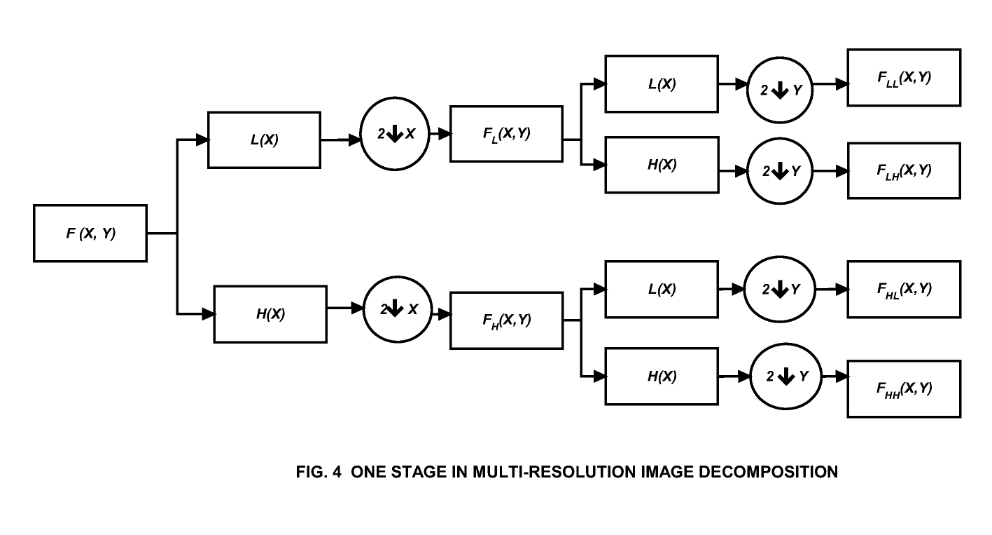

The pyramid-structured wavelet decomposition operation produces four subimages f_{LL}(x,y), f_{LH}(x,y), f_{HL}(x,y) and f_{HH}(x,y) in one level of decomposition. f_{LL}(x,y) is a smooth subimage, which represents the coarse approximation of the image. f_{LH}(x,y), f_{HL}(x,y) and f_{HH}(x,y) are detailed subimages, which represent the horizontal, vertical and diagonal directions of the image, respectively. The 2D decomposition can iterate on the smooth subimage f_{LL}(x,y) to obtain four coefficient matrices in the next decomposition level. FIG. 4 depicts one stage in a multi-resolution wavelet decomposition of an image.

Various types of wavelet bases such as Haar and Daubechies may be used in the wavelet decomposition. Empirical results indicate that due to the boundary effect of limited model image size, a wavelet basis with shorter supports such as the Haar wavelet with a support of 2 or a 4-tap Daubechies wavelet are the preferred choice. The type of wavelet bases has limited effects on the matching results.

The matching process can be performed either on the decomposed smooth subimage or on the decomposed detail subimage at a lower multi-resolution level. Preferably the system uses the detailed subimage for the matching with normalized correlation so that only pixels with high-energy values in the detail subimage are used as the matching candidates. This alleviates pixel-by-pixel matching in the smooth subimage. Three detail subimages containing, separately, horizontal, vertical and diagonal edge information of object patterns are obtained in one resolution level. The system may combine these three detail subimages into a single composite detailed subimage that simultaneously display horizontal, vertical and diagonal edge information. The composite subimage may be given by,

f_{c}^{(J)}(x,y)=|f_{LH}^{(J)}(x,y)|+|f_{HL}^{(J)}(x,y)|+|f_{HH}^{(J)}(x,y) (2)

where f_{LH}^{(J)}(x,y), f_{HL}^{(J)}(x,y) and f_{HH}^{(J)}(x,y) are the horizontal, vertical and diagonal detail subimages at resolution level J, respectively. The system may use the L1 norm as the energy function for each pixel in the composite detail subimage f_{d}^{(J)}(x,y) for its computational simplicity.

The online template matching may be carried out on the composite detail subimage. Since the energy values of most pixels in the detailed subimage are approximate to zero, only the pixels with high energy values are considered for further matching. The threshold for selecting high energy-valued pixels can be manually predetermined, fixed, or adaptively determined.

In order to reduce the computational burden in the matching process and make the matching invariance to rotation, a ring-projection transformation may be used 130. Overall, any generally rotation invariant technique may be used to characterize the image. It transforms a 2D gray-level image into a rotation-invariant representation in the 1D ring-projection space. Let the pattern of interest be contained in a circular window of radius W. The radius chosen for the window depends on the size of the reference template. The ring-projection of the composite detail subimage f_{d}^{(J)}(x,y) is gives as follows. First, f_{d}^{(J)}(x,y) in the Cartesian coordinates is transformed into the polar coordinates:

x=r cos θ y=r sin θ (3)

The ring-projection of image f_{d}^{(J)}(x,y) at radius r, denoted by p(r), is defined as the mean value of f_{d}^{(J)}(r cos θ,r sin θ) at the specific radius r. That is,

$$p ( r ) = \frac{1}{{n}_{r}} {\sum }_{k} {f}_{d}^{( J )} ( r cos {θ}_{k} , r sin {θ}_{k} ) \qquad ( 4 )$$

where nᵣ is the total number of pixels falling on the circle of radius r, r=0, 1, 2, . . . , W. Since the projection is constructed along circular rings of increasing radii, the derived 1D ring-projection pattern is invariant to rotation of its corresponding 2D image pattern. The pattern may be denoted at a model RPT vector, M 140. Other patterns or characterizations may likewise be used that are generally rotation invariant based upon a reduced resolution image.

It is noted that, in computing the RPT of an object, to avoid including other unwanted background pixels, the system preferably only adds together the wavelet coefficients of high energy pixels of equation 4. The maximum radius W is determined based on the model image size such that the rings cover the whole object. In addition, computing sin θ and cos θ at every pixel in the circle is time-consuming. To reduce time, the system may compute the distance transform of the center pixel of the ring, then all the pixels with radius r can be directly extracted with the distance map produced by distance transform.

The other part of the off-line model analysis relates to determining object orientation 150. The object orientation 150 may be computed as the principal axis of the object edge contour with moment analysis of the edge contour. This may include two steps: (1) extract object edges, and (2) compute moment of edges to obtain object orientation.

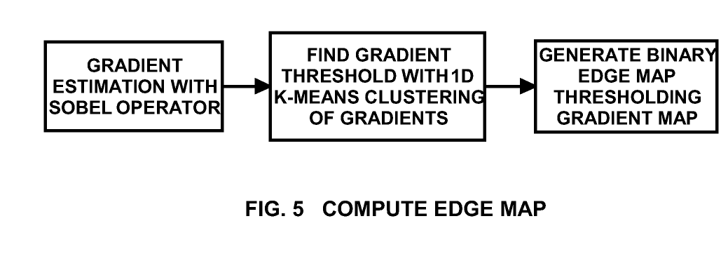

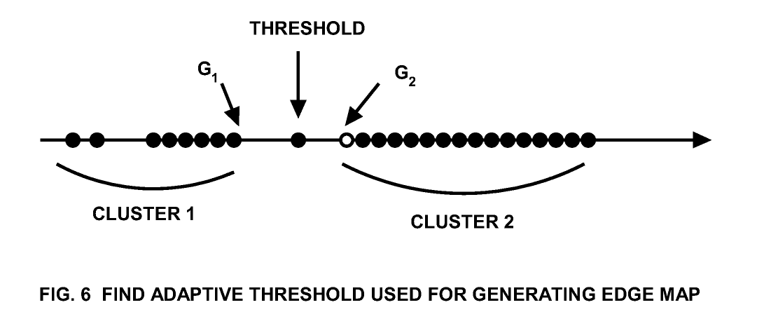

Referring also to FIG. 5, object edges 160 may be detected by first computing gradients with Sobel operator, then adaptively finding a gradient threshold with K-means clustering of the gradients into two clusters 170, and then generating the edge map with binarization of the gradients using the threshold 180. When finding the adatpive threshold, the system may cluster the gradeint amplitudes into two clusters with K-means clustering. Then the threshold is given by the smallest gradient (G2) in the cluster with larger centroid (cluster 2) minus the largest gradient (G1) in the cluster with smaller centroid (cluster 1), as shown in FIG. 6. The purpose of finding the threshold is to remove those gradients with low amplitude such as flat background pixels. Any other technique may be used to determine edges of an image.

After object edges are determined, object orientation may be determined by moment analysis of edge map 190. The object orientation may be determined in using any technique, as desired. The central moment of a digital image f(x,y) is defined as,

$${μ}_{pq} = {\sum }_{x} {\sum }_{y} {( x - \overline{x} )}^{p} {( y - \overline{y} )}^{q} f ( x , y ) \qquad ( 5 )$$

Information about image orientation can be derived by first using the second order central moments to construct a covariance matrix,

$${μ}_{20}^{′} = {μ}_{20} / {μ}_{00} \\ {μ}_{02}^{′} = {μ}_{02} / {μ}_{00} \\ {μ}_{11}^{′} = {μ}_{11} / {μ}_{00} \\ cov [ f ( x , y ) ] = [ \begin{matrix}{μ}_{20 }^{′} & {μ}_{11}^{′} \\ {μ}_{11}^{′} & {μ}_{02}^{′}\end{matrix} ] . \qquad ( 6 )$$

The eigenvectors of this matrix correspond to the major and minor axes of the edge pixels, so the orientation can be extracted from the angle of the eigenvector associated with the largest eigenvalue. It can be shown that this angle is given by

$$θ = \frac{1}{2} arctan ( \frac{2 {μ}_{11}^{′}}{{μ}_{20}^{′} - {μ}_{02}^{′}} ) \qquad ( 7 )$$

The model object orientation 150 is thus determined by the off line model analysis. In this manner, the system can determine not only the angular rotation of the object, but also its orientation.

During online template matching, the system receives the input image 200 and other parameters determined by offline model image analysis including number of wavelet decomposition layers P 210, model image RPT vector 220, gradient threshold T 230, and model object orientation θ_{M} 240.

The online template matching should likewise decompose the image to the P-th layer using a wavelet transformation so that processing is carried out on the composite detail subimage 250. Since the energy values of most pixels in the detailed subimage are approximate to zero, only the pixels with sufficiently high energy values are preferably considered for further matching. The threshold for selecting high energy-valued pixels can be manually predetermined, fixed, or adaptively determined. Any suitable image decomposition technique may be used.

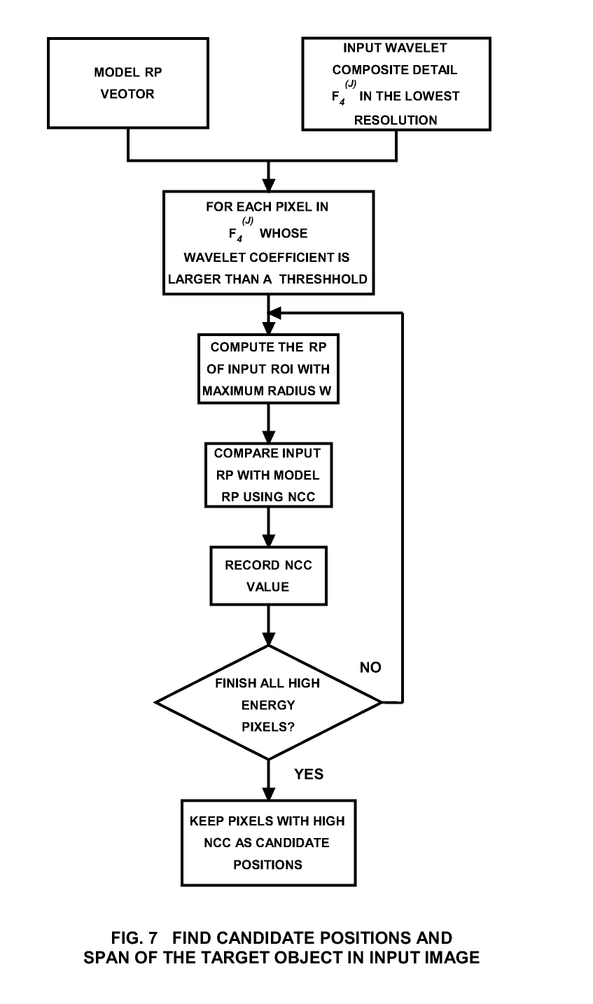

Also, referring to FIG. 7, candidate object position and span may be determined to be those circular windows with high Normalized Cross Correlation (NCC) similarity between model RP and the RP of a circular window centered at each high energy pixel in the lowest resolution wavelet composite subimage 260. A pre-defined similarity threshold can be used to discard false positive positions.

In the matching process, the measure of similarity is given by the normalized correlation. Let

P_{M}=[p(0), p(1), . . . , p(W)] (8)

and

P_{I}=[\hat{p}(0), \hat{p}(1), . . . , \hat{p}(W)] (9)

represent the ring-projection vectors of the reference template and scene subimage, respectively. The normalized correlation between ring projection vectors P_{M} and P_{I} is defined as:

$$\begin{matrix}{ρ}_{p} = \frac{{\sum }_{r = 0}^{W} [ p ( r ) - {μ}_{p} ] [ \hat{p} ( r ) - {\hat{μ}}_{p} ]}{{\{ {\sum }_{r = 0}^{W} {{[ p ( r ) - {μ}_{p} ]}^{2} [ \hat{p} ( r ) - {\hat{μ}}_{p} ]}^{2} \}}^{1 / 2}} & ( 10 ) \\ {μ}_{p} = \frac{1}{W + 1} {\sum }_{r = 0}^{W} p ( r ) \\ and & ( 11 ) \\ {\hat{μ}}_{p} = \frac{1}{W + 1} {\sum }_{r = 0}^{W} \hat{p} ( r ) & ( 12 )\end{matrix}$$

The correlation coefficient ρₚ is scaled in the range between −1 and +1. The computation of correlation coefficient is only carried out for those high energy-valued pixels in the composite detail subimage. Note that the dimensional length of the ring projection vector is W+1, where W is the radius of the circular window. This significantly reduces the computational complexity for the correlation coefficient ρₚ.

Once candidate positions of the target object are identified in the wavelet composite subimage at a lower resolution level, the system then verifies those candidates by computing the correlation coefficients in the vicinity of their corresponding ones in the original highest resolution image. Candidates with highest correlation coefficients are kept as the final target object position. Let (x*, y*) be the detected coordinates in the level J detail subimage. Then the corresponding coordinates of (x*, y*) in their level 0 image are given by (2^{J}x*, 2^{J}y*). If the localization error in one axis is Δt in the level J subimage, the search region in the original image should be (2^{J}x*±2^{J}Δt)×(2^{J}y*±2^{J}Δt) for fine tuning. Experiments show that the detected pixel with the largest correlation coefficient is typically within approximately 3-pixel distant from the true location for resolution level J<=2 and window radius W>=64.

The input object orientation, θ_{I}, 290 can be determined using the generally same technique as that off the off-line moment model analysis. Preferably the object area identified during the online template matching is downsampled 270, such as by a factor of 2, which is then used for edge detection and orientation estimation.

Since moment analysis of edge map only yields the angle of the principal axis of the object edges, so there is an ambiguity about the orientation: the orientation of angle θ can correspond to two different directions, these two directions are flipped with each other. This further means that the angle difference between model object and input object could be θ₁=0, θ_{I}−θ_{M} or θ₂=0, θ_{I}−θ_{M}+π, where θ_{I} denotes the input object orientation and θ_{M} denotes the model object orientation 280. To resolve this ambiguity when aligning model to input, the system may rotate 300 model image by θ₁ and θ₂ respectively, then compare the NCC matching score between input object region and rotated model image by θ₁ with the NCC score between the input object region and rotated model image by θ₂. This angle difference which yields highest NCC matching score 310 is selected 320.

To decrease the computational complexity in resolving orientation ambiguity, the NCC matching may be computed in the down-sampled image (original image is down-sampled by a factor of 2), which is provided by the off-line model analysis 330. To further reduce the computational complexity the NCC matching when resolving orientation ambiguity, the NCC matching is only performed with the edge pixels not the entire intensity image. The model may be rotated and translated to align with the input 340.

One type of template matching technique is to search the target object by sliding a window of the reference template in a pixel-by-pixel basis (or other basis), and computing the degree of similarity between them, where the similarity metric is commonly given by correlation. The preferred correlation is a Normalized Cross Correlation (NCC). The matching feature may be, for example, an edge map of the model (or input) image, or the full intensity image of the model (or input) image. If the matching feature is the edge map of the object, it is using global object shape information for matching, and hence provides advantages over feature point based matching.

For example, some advantages of NCC based template matching is (1) it is robust to object shapes, be it complex or simple shapes (2) it is robust to photometric changes (brightness/contrast changes, blur, noise, etc). However, one drawback of traditional NCC matching is that it is not robust to rotation, thus computation cost is high when the input object orientation is different from the model object orientation because many template images at different orientations are matched with the input image. Accordingly, a modified NCC matching technique should handle both rotation and translation of the image, preferably in a computationally efficient manner.

To enable NCC to match an object with different rotations, a set of rotated template images may be determined and then matched to the input image to find the optimal input orientation and position. To increase the matching efficiency, the preferred system may employ acceleration techniques such as a Fourier Transform, a coarse-to-fine multi-resolution search, and an integral image. In addition to using such acceleration techniques, if desired, the orientation search may be further modified for computational efficiency with coarse-to-fine hierarchical angle search. The coarse-to-fine angle search preferably occurs in the orientation domain (i.e. different angles). In addition, the technique may likewise be suitable for multi-object matching.

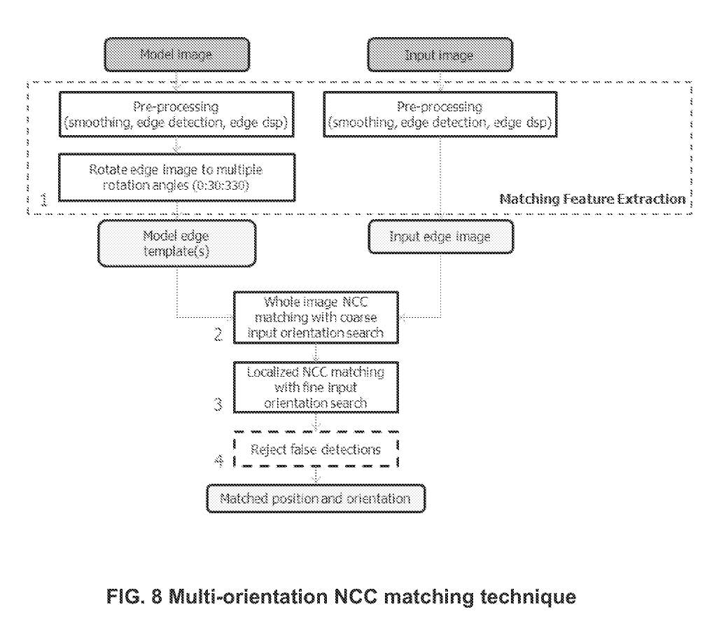

Referring to FIG. 8, a modified system is suitable for accommodating differences in the orientation of object(s) in the input image from the orientation of the object in the model image.

By way of background for traditional NCC matching, when a (2h+1)×(2w+1) template y is matched with an input image x, template matching is performed by scanning the whole image and computing the similarity between the template and the local image patch at every input pixel. Various similarity metrics can be used such as normalized Euclidean distance, Summed Square Distance (SSD) or Normalized Cross Correlation (NCC). If NCC is used as the similarity measure in the template matching, then the system can use NCC-based template matching. A conventionally used NCC-based template matching takes the form

$$\begin{matrix}NCC ( u , v ) = \frac{{\sum }_{i = - h}^{h} {\sum }_{j = - w}^{w} X ( i , j ) Y ( i , j )}{\sqrt{{\sum }_{i = - h}^{h} {\sum }_{j = - w}^{w} {X ( i , j )}^{2}} \sqrt{{\sum }_{i = - h}^{h} {\sum }_{j = - w}^{w} {Y ( i , j )}^{2}}} \\ with & ( 8 ) \\ X ( i , j ) = x ( u + i , v + j ) - \overline{x} \\ Y ( i , j ) = y ( h + i , w + j ) - \overline{y} \\ \overline{x} = \frac{1}{( 2 h + 1 ) ( 2 w + 1 )} {\sum }_{i = u - h}^{u + h} {\sum }_{j = v - w}^{v + w} x ( i , j ) \\ \overline{y} = \frac{1}{( 2 h + 1 ) ( 2 w + 1 )} {\sum }_{i = - h}^{h} {\sum }_{j = - w}^{w} y ( h + i , w + j ) . & ( 9 )\end{matrix}$$

NCC(u, v) gives the matching NCC score at position (u, v). The higher the NCC score at (u, v), the more similar template pattern is to the input local pattern at the neighborhood of (u, v). The input position that yields the highest NCC score across the whole input image is selected as the final matched position, as shown by equation (10).

$$( {u}^{′} , {v}^{′} ) = {argmax}_{{0 \leq u < H}_{0 \leq v < W}} [ NCC ( u , v ) ] \qquad ( 10 )$$

If there are multiple objects in the input and their orientation are all the same as the template object orientation, the system may keep the top K peaks in equation (10) where K corresponds to the number of objects in the input. While this technique is suitable to handle translation of an object, it is not suitable to handle rotation of an object.

Before entering to the matching stage, the system should first compute the feature used for matching. For NCC-based matching, one or two types of features are preferably employed. One feature for a matching feature is an object edge. Object edge encodes the global shape information about the object. It is more robust to object shape variations and it can potentially handle cases including simple-shape objects, symmetric objects, and objects with repetitive patterns. However, using the object edge often requires that object edge can be extracted from the input and the template image, which implies that it is not excessively robust to low contrast, noise, and blur in the input image because it is problematic to extract clean and clear object edges from such images.

Another feature for a matching feature is a gray-scale image, that is, using the raw gray-scale image for NCC matching. The use of such a gray-scale image is typically more robust to low contrast, nose, and blur. However, using the raw gray-scale image technique is not excessively robust to brightness/illumination changes in the input image. It also typically fails to obtain a valid matching result if the input intensity sufficiently deviates from the model intensity.

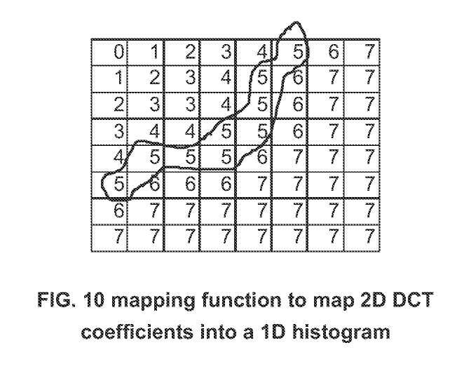

One automatic technique for determine a matching feature is to determine the input image blur and noise level based on frequency domain analysis. One particular transform that may be used in image capture is a discrete cosine transform (DCT). The DCT coefficients may form 64 (8×8) histograms, with one histogram for each of the DCT coefficients. To further reduce the data, these histograms for the 2-D 8×8 coefficients are mapped to 1-D histograms using a mapping function as illustrated in FIG. 10. For an example, all the histograms for the nine coefficients circled in FIG. 10 may be averaged to form a new histogram. This is generally equivalent to radial frequency spectrum used in power spectrum analysis.

With the 1D histogram, various statistics may be derived from these coefficient histograms, e.g. second order statistics variance, fourth order statistics kurtosis, maximum, and minimum, etc. Many of these can be used to predicted blur and noise. Preferably, the standard deviation (square-root of variance) of the DCT coefficients and absolute maximum DCT coefficients are used for blur detection, and the high frequency components are used to predict noise.

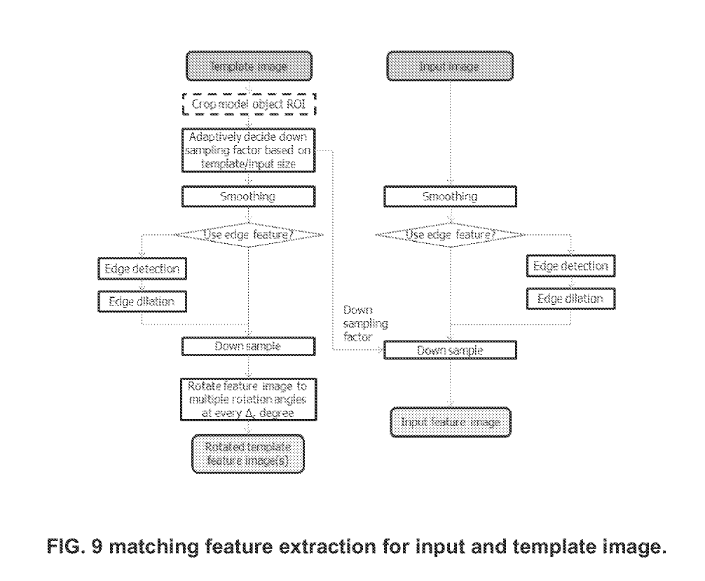

The matching feature extraction for template image matching illustrated in FIG. 8, is shown in more detail in FIG. 9. Given a template image containing the target object, the feature image used for matching may be computed as follows. First, the region of interest (ROI) that contains the target object is cropped from original model image. This step is skipped if given template image is already the object ROI itself (i.e. given template contains only the target object). Second, determine the down sample factor based on template and/or input size adaptively such that the lowest resolution of the template or input image where actual NCC takes place is no smaller than 64×64. Third, the template image is smoothed to remove unwanted noise. Any low-pass-filtering-based smoothing may be used, including Gaussian low pass filtering, block averaging and/or bilateral filtering. Gaussian low-pass filtering is faster than bilateral filtering. Third, if an object edge is used for matching, the system may detect edges (e.g. Canny edge detection or other contour/edge extraction method) and dilate edge with morphological processing. The purpose of edge dilation is to reduce edge/contour breaking caused by subsequent down sampling. If gray-scale is used for matching, then the smoothed input will be directly down sampled by the next down sampling step. Next, the original resolution feature image, either edge or gray-scale, is down sampled to obtain a lower resolution feature image. The actual NCC matching may be performed with the down sampled feature image in order to reduce computation cost. In the last step, the down sampled feature image is rotated many times to obtain multiple templates, each with a different orientation. In the preferred embodiment, the template is rotated 360 times at every 1 degree, and all of the 360 down sampled and rotated templates are stored for later angle search.

Feature extraction for input image is shown in the right path of FIG. 9. The processing is similar to the template image feature extraction. Note that input is down sampled preferably using the same down sampling factor as the template image. Note that the smoothing and edge detection parameters used for input and template image may be different. The down sampled input resolution is typically much larger than down sampled template resolution.

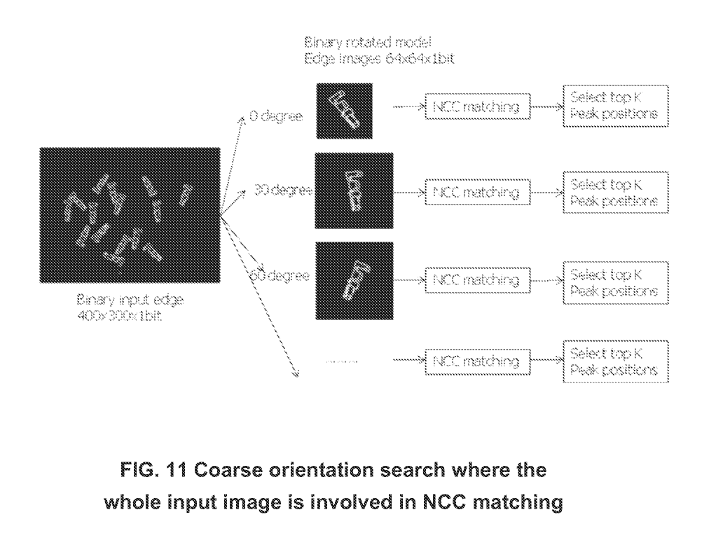

Referring again to FIG. 8, the whole image NCC matching with coarse input orientation search is further illustrated in FIG. 11. Given the template feature image and input feature image, next step is to perform NCC matching to find the position and the orientation of the target object in the input image. To reduce the computational complexity of the orientation and the position search, a hierarchical search may be used. In particular, the rotated templates at coarse angle intervals (e.g. every 30 degree) are first matched to input image, top K peak position of each of the coarse angles are maintained. Then, the rotated templates at fine angle interval around the coarse angle are matched to the input image.

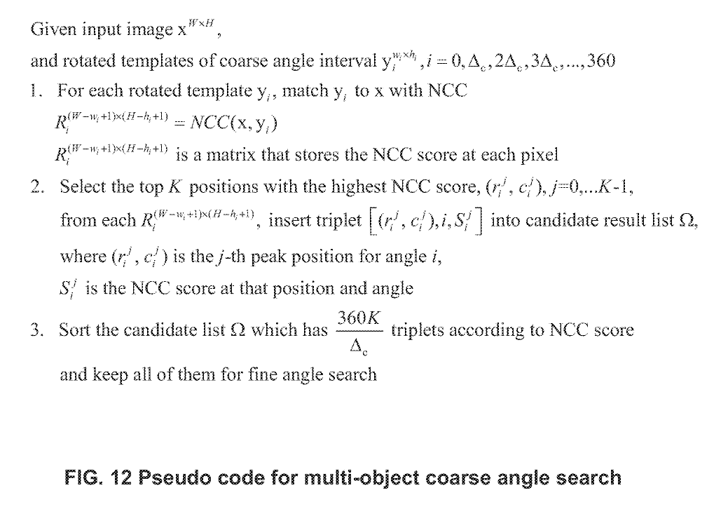

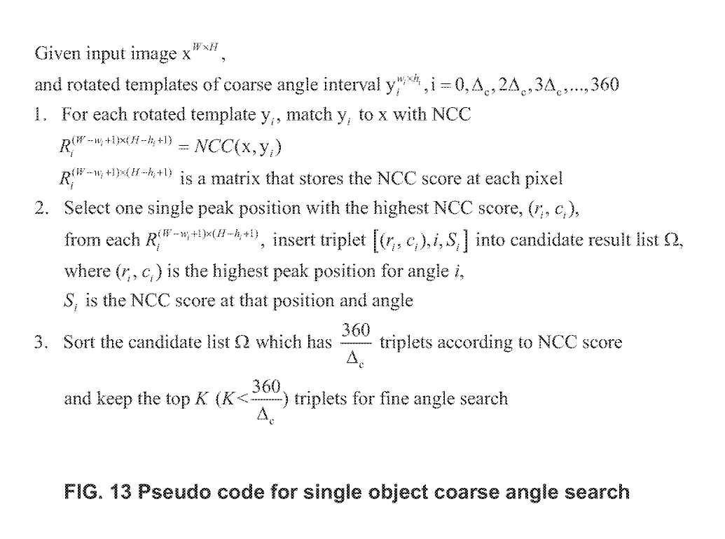

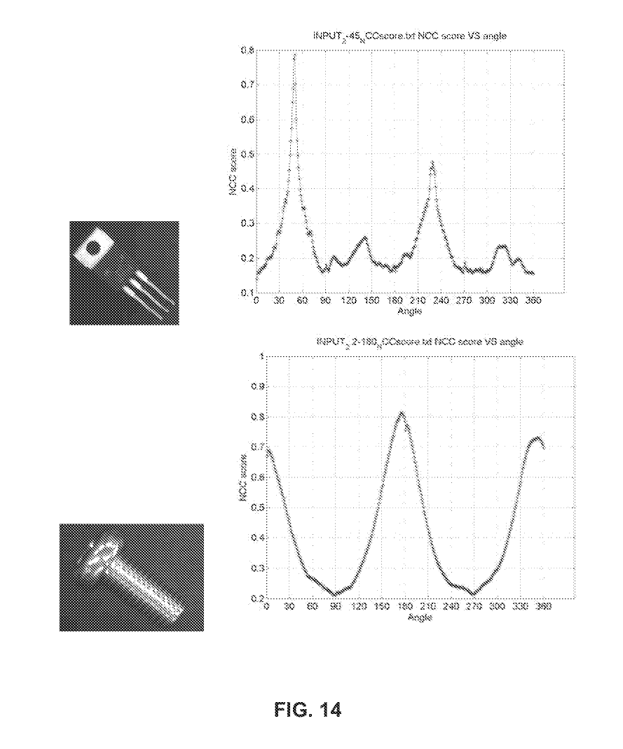

The preferred coarse matching procedure pseudo code is illustrated in FIG. 12 for multi-objects, while FIG. 13 illustrates pseudo code for a single object coarse angle search. For the coarse angle search the entire input image may be involved in NCC matching. The efficiency and accuracy of coarse orientation search is controlled by coarse angle interval Δ, the larger the Δ, the faster the coarse search, and the more in accurate the matching will be. For example, searching every 5 degree takes longer time than searching every 30 degree, but searching every 5 degree will lead to more precise orientation than searching every 30 degree. Some types of objects are more suited to small coarse sampling interval (e.g. 10 degree) in order to achieve high matching accuracy, but for some other type of objects, larger coarse sampling interval (e.g. every 30 degree) is sufficient to achieve high matching accuracy meanwhile large coarse sampling interval takes much less time. Therefore, in order to achieve fast matching speed and high accuracy simultaneously, it is preferable to dynamically determine a coarse sampling interval. The preferred technique to determine the coarse sampling interval Δ_{c} is dynamically based on the width of the peaks of the NCC score curve between the original template and the rotated templates. First, the system computes the NCC between the original template and each of the rotated templates (obtained by rotating original template at every 1 degree). Then all of these NCC scores are plotted in a curve where the x-axis if the rotating degree, y-axis is the NCC score. Next, the system identifies the highest peak of the NCC curve plot, and fits a Gaussian function to this peak. Then the width of the highest peak is computed as the variance of the fitted Gaussian function. Finally, the coarse sampling interval is set to be proportional to the peak width. That is, the narrower the width of the highest peak, the smaller the coarse sampling interval to avoid missing the peak due to the fast NCC score decay, and vice versa. FIG. 14 illustrates two sample objects and their NCC plot, the top row object should use small coarse sampling interval whereas the bottom row screw object should use large coarse sampling interval.

The difference between single object and multi-object matching is that, for single object coarse angle search, the system only keeps one single peak position which yields the highest NCC score, then the top K [angle, position] triplets among all coarse angles are kept for future fine orientation search. Whereas, in the case of multi-object matching, since it is possible that there could be multiple object with the same orientation in an input image, the system may keep the top K positions for each coarse angle.

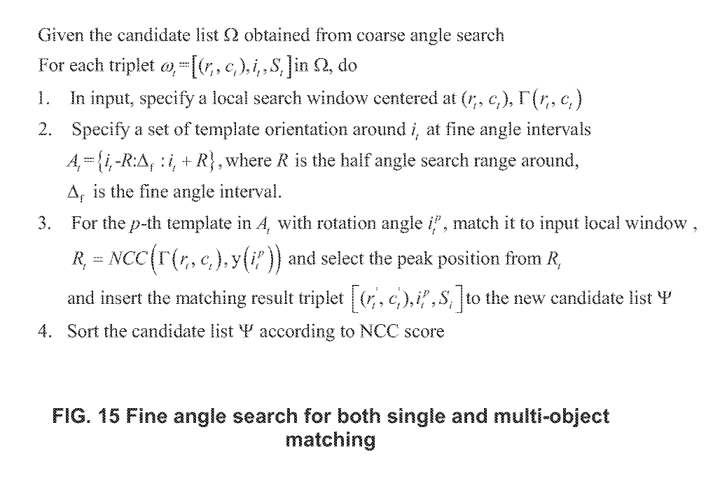

Referring again to FIG. 8, the localized NCC matching with fine input orientation search may be used to achieve better orientation precision. An orientation search at finer angle interval around the coarse angle is performed within a local neighborhood of the position found by coarse angle search. For example, suppose one matching candidate result returned by coarse angle search is [(720,350),120°,0.861], where (720,350) is the horizontal and vertical coordinates of the position, 120° represents how many degree of rotation the input object is detected to be rotated from template object orientation by the coarse angle search, 0.86 is the NCC score at that position and orientation. Then the system may specify the set of templates with fine angle interval, for example every 2° around 120°, i.e. templates whose rotation angle is 100°, 102°, 104°, . . . , 120°. Then these sets of templates may be matched to a local input window centered at (720,350) with NCC. This process is repeated for all of the triplets in the candidate list, and all of the matching results of fine orientation search will be kept in another candidate list. The preferred fine matching procedure pseudo code is illustrated in FIG. 15.

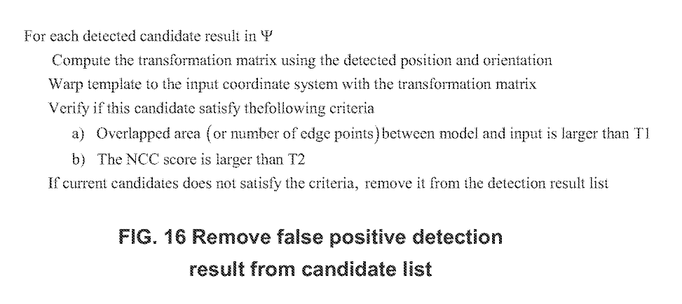

Referring again to FIG. 8, after coarse and fine orientation search, the candidate list Ψ stores the entire candidate matching results. In addition to the true objects, there might be false positive detections (non-object is detected as object), so the system should remove those false positive detections from the candidate list. An exemplary false detection removal technique is illustrated in FIG. 16.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for image processing comprising:
(a) decomposing a model image into at least one lower resolution image;
(b) determining generally rotation invariant characteristics of a model object of said lower resolution image;
(c) determining an object orientation of said model object of said lower resolution image using an edge based technique;
(d) decomposing said image into at least another lower resolution image;
(e) determining a candidate test object's position within said another lower resolution image;
(f) determining an orientation of said test object using an edge based technique;
(g) resolving orientation ambiguity of said test object.

2. The method of claim 1 wherein said decomposing said model image includes wavelet decomposition.

3. The method of claim 2 wherein said wavelet composition includes a plurality of lower resolutions.

4. The method of claim 3 wherein said at least one lower resolution includes the lowest resolution of said plurality of lower resolutions.

5. The method of claim 1 wherein said generally rotation invariant characteristics of said model object includes a ring projection transform.

6. The method of claim 1 wherein said lower resolution image and said another lower resolution image have the same resolution.

7. The method of claim 1 wherein said candidate test object's position is based upon measuring a similarity between said object rotation of said model object and said orientation of said test object.

8. The method of claim 1 wherein said lower resolution image has a minimum threshold.

9. The method of claim 1 wherein said lower resolution image is based upon said model image.

10. The method of claim 3 wherein the number of said plurality of lower resolutions is adaptively determined.

11. The method of claim 5 wherein said generally rotation invariant characteristics of said model object includes a one dimensional characteristic as a function of radius.

12. The method of claim 11 wherein said characteristics are further based upon a distance transform.

13. The method of claim 7 wherein said candidate test object's position is further based upon a normalized cross correlation.

14. The method of claim 1 wherein said determining said orientation of said test object using said edge based technique includes image gradients.

15. A method for image processing comprising:
(a) receiving a plurality of model object templates, each of which relates to a different orientation of a model object;
(b) performing a coarse angle search by matching said model object templates with a normalized cross correlation representation of said image over a first range of angles, wherein a sampling interval of said first range of angles is dynamically determined based upon said normalized cross correlations of different rotated model images;
(c) performing a fine angle search by matching said object templates with a normalized cross correlations representation of said image of a second range of angles, wherein said second range of angles is less than said first range of angles;
(d) identifying an object in said image based upon said fine angle search.

16. The method of claim 15 wherein said second range of angles is based upon the highest set of normalized cross correlations as a result of said coarse angle search.

17. The method of claim 16 wherein a matching with the highest normalized cross correlation score is selected as a matching result.

18. The method of claim 17 wherein said model object template is based upon at least one of an object edge image and an object gray-scale image.

19. The method of claim 18 wherein said image includes a plurality of objects, each of which is identified.
